(19) United States
(12) Patent Application Publication
(10) Pub. No.: US 2009/0294538 A1
(43) Pub. Date: Dec. 3, 2009

(54) EMBEDDED TAGS IN A MEDIA SIGNAL

(75) Inventors: Anders Wihlborg, Rydeback (SE); Jonas Claesson, Malmo (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/128,397

(22) Filed: May 28, 2008

(51) Int. Cl. G06K 7/10

(52) U.S. Cl. 235/454

(57) ABSTRACT

A mobile device may capture video of a media signal, parse frames of the captured video, and identify a tag within one or more of the frames of the captured video, where the tag includes a machine-readable representation of information. The mobile device may also analyze the tag to determine the information included in the tag, and present particular information based on the information included in the tag.

### BACKGROUND

The proliferation of devices, such as handheld and portable devices, has grown tremendously within the past decade. A majority of these devices include some kind of display to provide a user with visual information. These devices may also include an input device, such as a keypad, a touch screen, a camera, and/or one or more buttons to allow a user to enter some form of input. However, in some instances, the input device may have high costs or limit the space available for other components, such as the display. In other instances, the capabilities of the input device may be limited.

### SUMMARY

According to one implementation, a method, performed by a mobile device, may include capturing video of a media signal; parsing frames of the captured video; identifying a tag within one or more of the frames of the captured video, where the tag includes a machine-readable representation of information; analyzing the tag to determine the information included in the tag; and presenting particular information based on the information included in the tag.

Additionally, the mobile device may include a video capturing device, and capturing video of the media signal may include activating the video capturing device, and recording, by the video capture device, a video of the media signal.

Additionally, the media signal may be played on a video display device, and capturing video of the media signal may include recording a video of the media signal as the media signal is played on the video display device.

Additionally, identifying the tag within the one or more frames of the captured video may include locating a blank frame from among the frames of the captured video, and detecting the tag within the blank frame.

Additionally, identifying the tag within the one or more frames of the captured video may include locating a blank area within one of the frames of the captured video, where the blank area is smaller than an entire area of the one of the frames, and detecting the tag within the blank area.

Additionally, identifying the tag within the one or more frames of the captured video may include analyzing a series of the frames of the captured video to identify changes in a visual aspect, and detecting the tag based on the changes in the visual aspect.

Additionally, the information included in the tag may include an address, and presenting the particular information may include accessing a web page corresponding to the address, and displaying the web page as the particular information.

Additionally, the information included in the tag may include a message that contains text, and presenting the particular information may include displaying the text of the message as the particular information.

Additionally, identifying the tag within the one or more frames of the captured video may include identifying multiple tags within the one or more frames of the captured video, and presenting the particular information may include displaying, as the particular information, a selectable list of information regarding each of the tags.

According to another implementation, a mobile device may include a video capturing device and processing logic. The video capturing device may capture video of a media signal presented on a video display device. The processing logic may identify frames of the captured video, identify a tag within one or more of the frames of the captured video, where the tag may include a machine-readable representation of information, analyze the tag to determine the information included in the tag, and perform a particular function based on the information included in the tag.

Additionally, the information included in the tag may include a telephone number, and when performing the particular function, the processing logic may initiate a telephone call based on the telephone number, or send a text message based on the telephone number.

Additionally, the tag may encode one or more of an address, a keyword, or a message.

Additionally, when identifying the tag within the one or more frames of the captured video, the processing logic may locate a blank frame or a semi-transparent frame from among the frames of the captured video, and detect the tag within the blank frame or the semi-transparent frame.

Additionally, when identifying the tag within the one or more frames of the captured video, the processing logic may locate a blank area within one of the frames of the captured video, where the blank area is smaller than an entire area of the one of the frames, and detect the tag within the blank area.

Additionally, when identifying the tag within the one or more frames of the captured video, the processing logic may analyze a series of the frames of the captured video to identify changes in a visual aspect, and detect the tag based on the changes in the visual aspect.

Additionally, the information included in the tag may include a keyword, the mobile device may further include a display, and when performing the particular function, the processing logic may cause a search to be performed based on the keyword, obtain search results based on the search, and present the search results on the display.

Additionally, the tag may be associated with an object visible within the media signal on the video display device, the mobile device may further include a display, and when performing the particular function, the processing logic may present information regarding the object on the display.

According to a further implementation, a mobile device may include means for capturing video of a media signal that is being displayed on a video display device; means for identifying frames of video within the captured video; means for detecting a tag within one or more of the frames, where the tag includes a machine-readable representation of information; means for analyzing the tag to determine the information included in the tag; and means for outputting data based on the information included in the tag.

Additionally, the means for identifying the frames of video within the captured video may include means for processing the video of the media signal continuously in approximately real time to identify the frames of video while the video of the media signal is being captured.

Additionally, the means for detecting the tag within the one or more frames may include means for analyzing a series of the frames of the captured video to identify changes in a visual aspect, and means for detecting the tag based on the changes in the visual aspect.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a diagram of an overview of implementations described herein;

FIG. 2 is a diagram of an exemplary environment in which systems and methods described herein may be implemented;

FIGS. 3A and 3B are diagrams of exemplary external components of the mobile device shown in FIG. 2;

FIG. 4 is a diagram of exemplary components that may be included in the mobile device shown in FIG. 2;

FIG. 5 is a flowchart of an exemplary process for embedding a tag within a media signal;

FIGS. 6-9 are diagrams of exemplary frames of a media signal in which a tag may be inserted;

FIG. 10 is a flowchart of an exemplary process for processing a tag within captured video; and

FIGS. 11-15 are diagrams showing exemplary functions that may be performed by a mobile device in processing a tag within captured video.

### DETAILED DESCRIPTION OF EMBODIMENTS

The following detailed description refers to the accompanying drawings. The same reference numbers in different drawings may identify the same or similar elements. Also, the following detailed description does not limit the invention.

### Overview

Implementations described herein may embed a tag within a media signal and permit a mobile device to capture video of the media signal and process the embedded tag to provide additional information regarding an object depicted within the video portion of the media signal. A “tag,” as used herein, is intended to be broadly interpreted to include a machine-readable representation of information. The information in the tag may be used in certain functions, such as to obtain additional information regarding a particular object or to transmit certain information to a particular destination.

A tag may encode a small amount of information, such as approximately twenty or fewer bytes of data—though larger tags are possible and within the scope of this description. In one implementation, a tag may take the form of a one or two-dimensional symbol. In another implementation, a tag may take the form of differences in a visual aspect over time. A tag may contain one or more addresses, such as one or more Uniform Resource Locators (URLs), Uniform Resource Identifiers (URIs), e-mail addresses, or telephone numbers, from which information may be obtained or to which information may be transmitted. Alternatively, or additionally, a tag may include one or more keywords that may be used to perform a search. Alternatively, or additionally, a tag may contain a message.

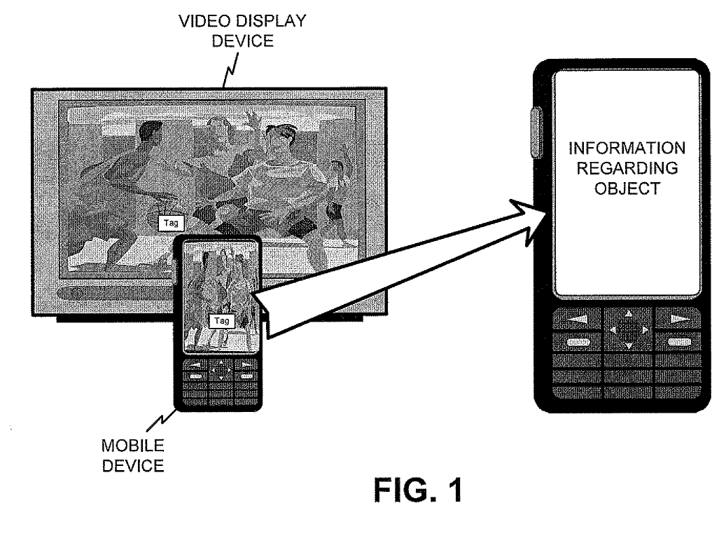

FIG. 1 is a diagram of an overview of implementations described herein. A tag may be embedded within a media signal, such as a television signal, a media signal recorded on a memory device (e.g., a DVD or flash memory), a media signal from a network (e.g., the Internet), or a media signal from another source. The tag may be embedded within the media signal such that the tag is invisible to a human viewing the video portion of the media signal.

As shown in FIG. 1, a video display device, such as a television, may play the media signal with the embedded tag. The tag may be associated with an object present in the video portion of the media signal. In the example of FIG. 1, the tag includes information associated with the basketball that is being used in the basketball game shown on the video display device.

A user may use a mobile device that has video recording capability to capture video of the media signal that is playing on the video display device. For example, the user may position the mobile device so that a camera of the mobile device is directed toward the video display device. The user may activate a function, such as a camera function, on the mobile device. Activation of this function may cause, perhaps transparently to the user, the mobile device to capture the video of the media signal.

The mobile device may parse the captured video to identify the embedded tag. The mobile device may analyze the tag to determine the information that the tag includes and use this information to provide additional information regarding the object. For example, as shown in FIG. 1, the mobile device may obtain information regarding the object (i.e., the basketball in the example of FIG. 1), such as the make and model of the object, the cost of the object, a name of or a link to a seller of the object, a name of or a link to a service provider that can service the object, or other information that a user might find useful with respect to the object.

While the tag in FIG. 1 may permit additional information to be obtained regarding a particular object (i.e., a basketball), in other implementations, the tag may permit other functions to be performed. For example, a tag may permit an address of a web page to be added to a bookmark or favorites list. Alternatively, a tag may permit a message to be transmitted to a particular destination.

### Exemplary Environment

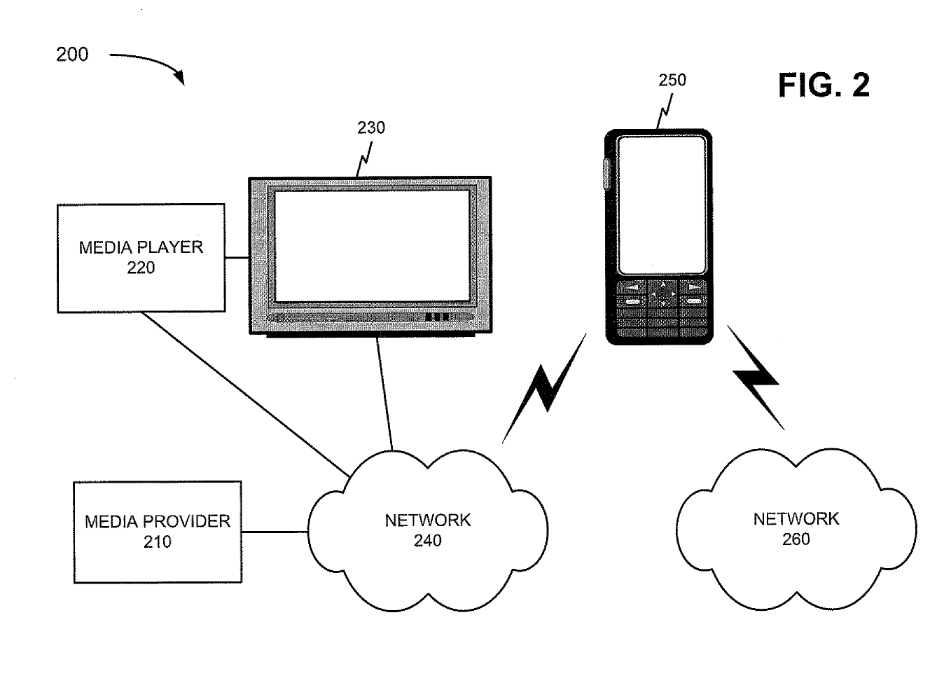

FIG. 2 is a diagram of an exemplary environment 200 in which systems and methods described herein may be implemented. Environment 200 may include media provider 210, media player 220, video display device 230, network 240, mobile device 250, and network 260. In practice, environment 200 may include more, fewer, different, or differently arranged devices than are shown in FIG. 2. Also, two or more of these devices may be implemented within a single device, or a single device may be implemented as multiple, distributed devices. Further, while FIG. 2 shows direct connections between devices, any of these connections can be indirectly made via a network, such as a local area network, a wide area network (e.g., the Internet), a telephone network (e.g., the Public Switched Telephone Network (PSTN) or a cellular network), or a combination of networks.

Media provider 210 may include a provider of a media signal. For example, media provider 210 may include a television broadcast provider (e.g., a local television broadcast provider and/or a for-pay television broadcast provider), an Internet-based content provider (e.g., media content from a web site), or another provider of a media signal (e.g., a DVD distributor). Media player 220 may include a device that may play a media signal on video display device 230. For example, media player 220 may include a set-top box, a digital video recorder (DVR), a DVD player, a video cassette recorder (VCR), a computer, or another device capable of outputting a media signal to video display device 230. Video display device 230 may include a device that may display a video portion of a media signal. For example, video display device 230 may include a television or a computer monitor.

Media provider 210, media player 220, and/or video display device 230 may connect to network 240 via wired and/or wireless connections. Network 240 may include, for example, a wide area network, a local area network, an intranet, the Internet, a telephone network (e.g., the PSTN or a cellular network), an ad hoc network, a fiber optic network, or a combination of networks.

Mobile device 250 may include a communication device with video recording capability. As used herein, a “mobile device” may include a radiotelephone; a personal communications system (PC S) terminal that may combine a cellular radiotelephone with data processing, a facsimile, and/or data communications capabilities; a personal digital assistant (PDA) that can include a radiotelephone, pager, Internet/intranet access, web browser, organizer, calendar, and/or global positioning system (GPS) receiver; a laptop; a gaming device; or another portable communication device.

Mobile device 250 may connect to network 240 and/or network 260 via wired and/or wireless connections. In one implementation, network 260 is the same network as network 240. In another implementation, network 260 is a network separate from network 240. Network 260 may include, for example, a wide area network, a local area network, an intranet, the Internet, a telephone network (e.g., the PSTN or a cellular network), an ad hoc network, a fiber optic network, or a combination of networks.

### Exemplary Mobile Device

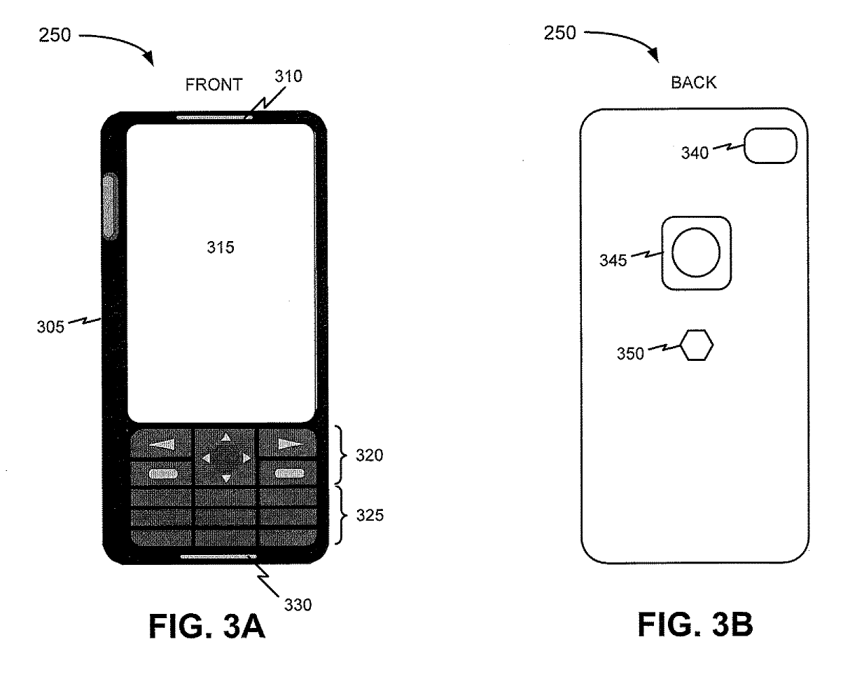

FIGS. 3A and 3B are diagrams of exemplary external components of mobile device 250. As shown in FIG. 3A, mobile device 250 may include a housing 305, a speaker 310, a display 315, control buttons 320, a keypad 325, and a microphone 330. Housing 305 may be made of plastic, metal, and/or another material that may protect the components of mobile device 250 from outside elements. Speaker 310 may include a device that can convert an electrical signal into an audio signal. Display 315 may include a display device that can provide visual information to a user. For example, display 315 may provide information regarding incoming or outgoing calls, games, phone books, the current time, Internet content, etc. Control buttons 320 may include buttons that may permit the user to interact with mobile device 250 to cause mobile device 250 to perform one or more operations. Keypad 325 may include keys, or buttons, that form a standard telephone keypad. Microphone 330 may include a device that can convert an audio signal into an electrical signal.

As shown in FIG. 3B, mobile device 250 may further include a flash 340, a lens 345, and a range finder 350. Flash 340 may include a device that may illuminate a subject that is being captured with lens 345. Flash 340 may include light emitting diodes (LEDs) and/or other types of illumination devices. Lens 345 may include a device that may receive optical information related to an image. For example, lens 345 may receive optical reflections from a subject and may capture a digital representation of the subject using the reflections. Lens 345 may include optical elements, mechanical elements, and/or electrical elements. An implementation of lens 345 may have an upper surface that faces a subject being photographed and a lower surface that faces an interior portion of mobile device 250, such as a portion of mobile device 250 housing electronic components. Range finder 350 may include a device that may determine a range from lens 345 to a subject (e.g., a subject being captured with lens 345). Range finder 350 may be connected to an auto-focus element in lens 345 to bring a subject into focus with respect to lens 345. Range finder 350 may operate using ultrasonic signals, infrared signals, etc.

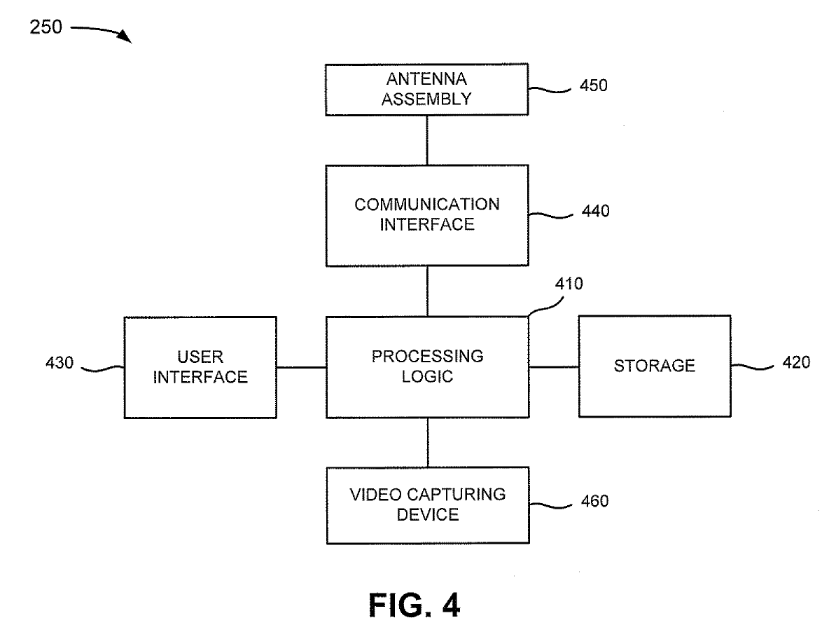

FIG. 4 is a diagram of exemplary components that may be included in mobile device 250. As shown in FIG. 4, mobile device 250 may include processing logic 410, storage 420, user interface 430, communication interface 440, antenna assembly 450, and video capturing device 460. In practice, mobile device 250 may include more, fewer, different, or differently arranged components. For example, mobile device 250 may include a source of power, such as a battery.

Processing logic 410 may include a processor, microprocessor, an application specific integrated circuit (ASIC), a field programmable gate array (FPGA), or the like. Processing logic 410 may include data structures or software programs to control operation of mobile device 250 and its components. Storage 420 may include a random access memory (RAM), a read only memory (ROM), a flash memory, a buffer, and/or another type of memory that may store data and/or instructions that may be used by processing logic 410.

User interface 430 may include mechanisms for inputting information to mobile device 250 and/or for outputting information from mobile device 250. Examples of input and output mechanisms might include a speaker (e.g., speaker 310) to receive electrical signals and output audio signals, a microphone (e.g., microphone 330) to receive audio signals and output electrical signals, buttons (e.g., control buttons 320 and/or keys of keypad 325) to permit data and control commands to be input into mobile device 250, a display (e.g., display 315) to output visual information, and/or a vibrator to cause mobile device 250 to vibrate.

Communication interface 440 may include, for example, a transmitter that may convert baseband signals from processing logic 410 to radio frequency (RF) signals and/or a receiver that may convert RF signals to baseband signals. Alternatively, communication interface 440 may include a transceiver to perform functions of both a transmitter and a receiver. Communication interface 440 may connect to antenna assembly 450 for transmission and reception of the RF signals. Antenna assembly 450 may include one or more antennas to transmit and receive RF signals over the air. Antenna assembly 450 may receive RF signals from communication interface 440 and transmit the RF signals over the air, and receive RF signals over the air and provide the RF signals to communication interface 440.

Video capturing device 460 may include a device that may perform electronic motion picture acquisition (referred to herein as “video capture” to obtain “captured video”). Video capturing device 460 may provide the captured video to a display (e.g., display 315) in near real time for viewing by a user. Additionally, or alternatively, video capturing device 460 may store the captured video in memory (e.g., storage 420) for processing by processing logic 410. Video capturing device 460 may include an analog-to-digital converter to convert the captured video to a digital format.

### Exemplary Process for Embedding a Tag

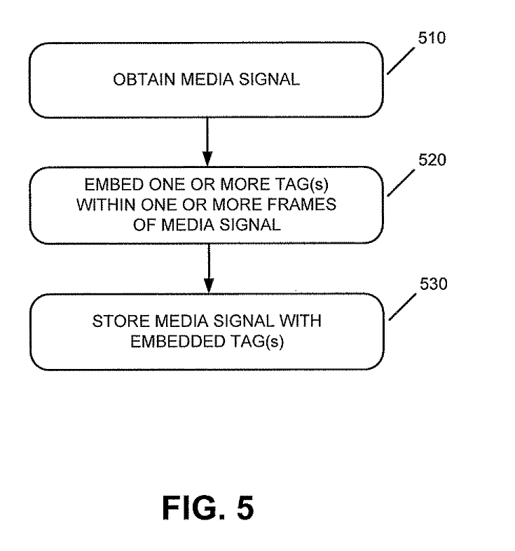

FIG. 5 is a flowchart of an exemplary process for embedding a tag within a media signal. The process of FIG. 5 may be performed by a party that creates a media signal, by a party that distributes a media signal, such as media provider 210 (FIG. 2), or by a party that modifies a media signal.

The process may commence with obtaining a media signal (block 510). The media signal may be obtained by creating the media signal or by receiving the media signal for distribution or modification. The media signal may contain a video portion that includes a number of frames.

One or more tags may be embedded within one or more frames of the media signal (block 520). The technique used to embed a tag within the media signal may make the tag invisible to viewers of media signal. The particular technique used may be influenced by the amount of processing power required to successfully recognize the tag. While four particular techniques are described below, in other implementations, yet other techniques may be used.

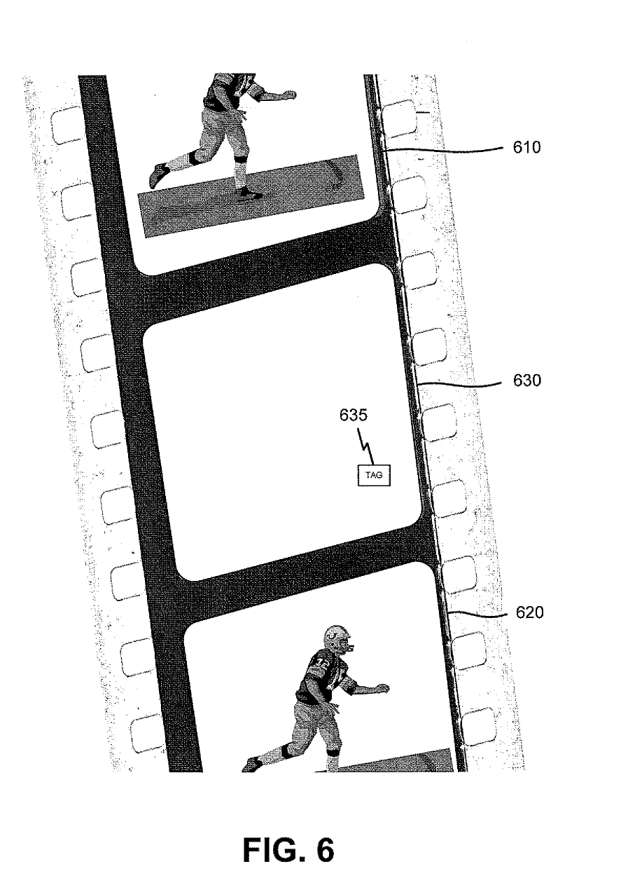

One technique may include replacing a video frame, within the media signal, with a blank frame that contains the tag. As shown in FIG. 6, three video frames within the media signal may include video frames 610, 620, and 630. One video frame, such as video frame 630, may be replaced with a blank frame 630. Blank frame 630 may include a tag 635 associated with a particular object depicted in video frames 610, 620, and 630. As described above, tag 635 may include a machine-readable representation of information, such as an address, a keyword, or a message. Tag 635 may be large enough to convey the information. To make blank frame 630, and, thus, tag 635, invisible to a viewer, blank frame 630 may replace approximately one video frame in approximately thirty video frames.

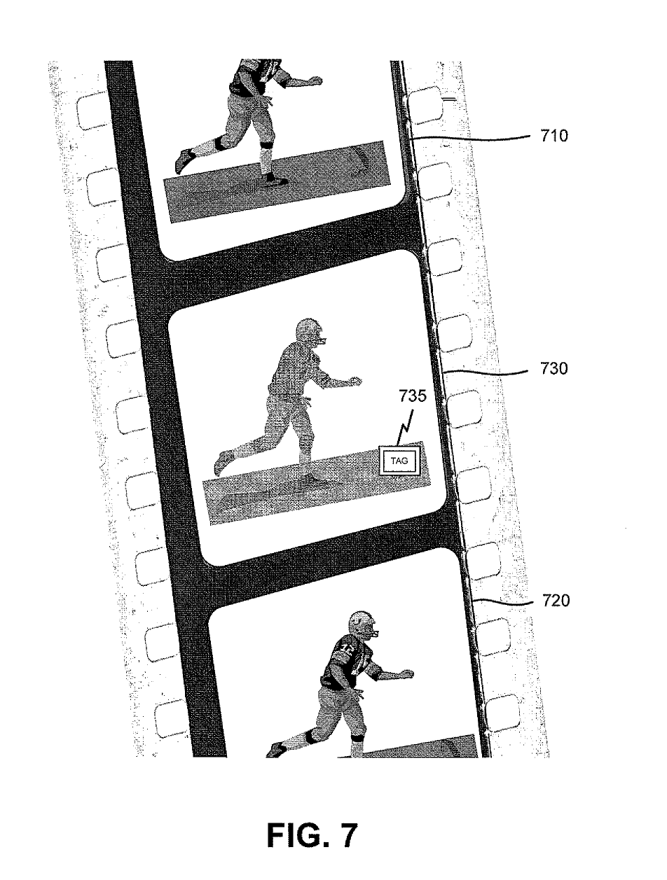

Another technique may include replacing a video frame, within the media signal, with a semi-transparent frame that contains the tag. As shown in FIG. 7, three video frames within the media signal may include video frames 710, 720, and 730. One video frame, such as video frame 730, may be replaced with a semi-transparent frame 730. Semi-transparent frame 730 may include a semi-transparent version of video frame 730. Semi-transparent frame 730 may include a tag 735 associated with a particular object depicted in video frames 710, 720, and 730. As described above, tag 735 may include a machine-readable representation of information, such as an address, a keyword, or a message. Tag 735 may be large enough to convey the information. To make tag 735 invisible to a viewer, semi-transparent frame 730 may replace one video frame in approximately thirty video frames.

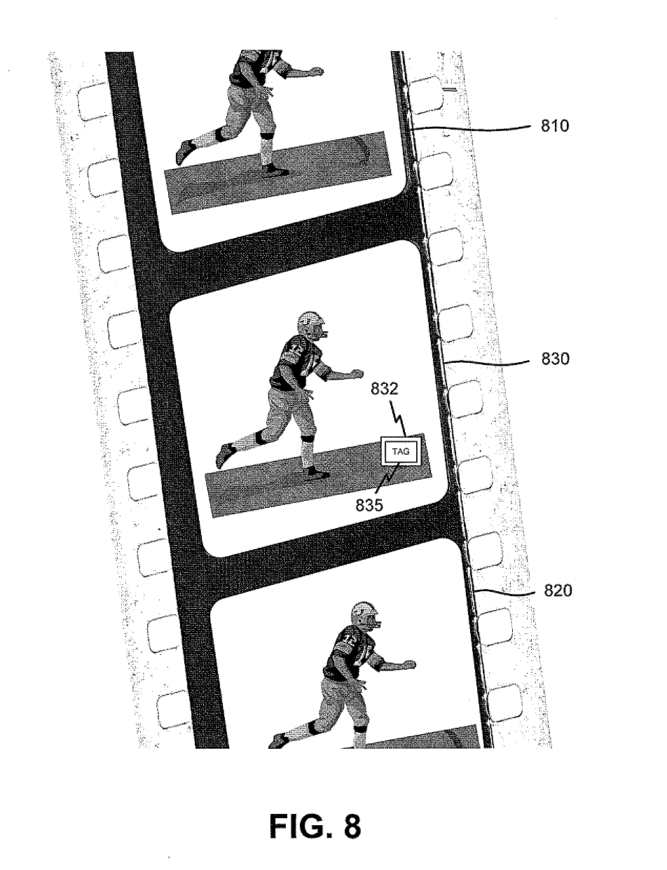

Yet another technique may include inserting a tag within a blank area of a video frame of the media signal. As shown in FIG. 8, three video frames within the media signal may include video frames 810, 820, and 830. A blank area 832 may be inserted into one frame, such as video frame 830. A tag 835, associated with a particular object depicted in video frames 810, 820, and 830, may be inserted into blank area 832. Similar to the previous techniques, tag 835 may include a machine-readable representation of information, such as an address, a keyword, or a message. Tag 835 may be large enough to convey the information. To make tag 835 invisible to a viewer, tag 835 may be inserted into one video frame in every approximately thirty video frames.

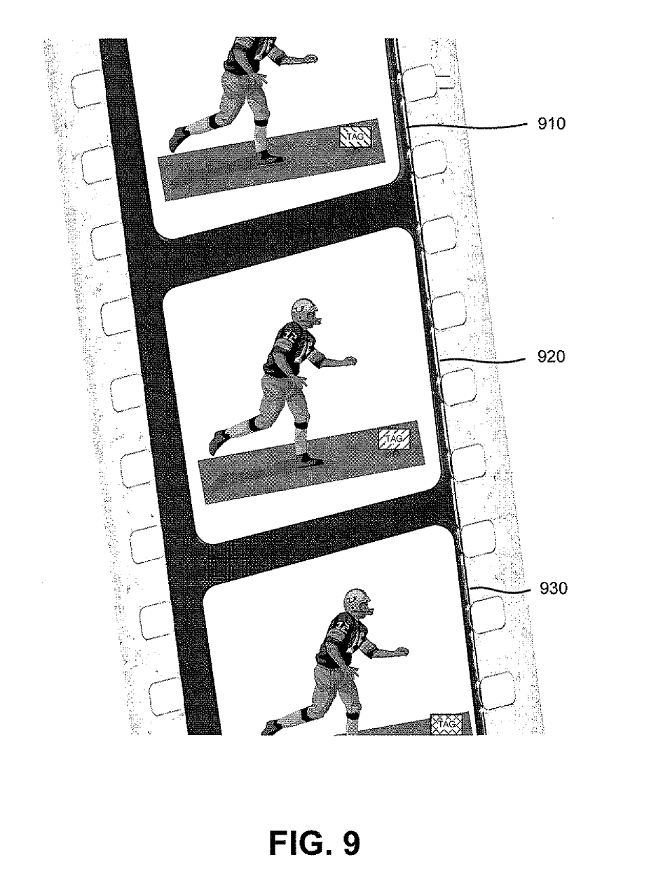

A further technique may include inserting a tag, as changes in a visual aspect, such as color and/or contrast, within a series of video frames. As shown in FIG. 9, three video frames within the media signal may include video frames 910, 920, and 930. A tag, associated with a particular object depicted in video frames 910, 920, and 930, may be inserted into each of video frames 910, 920, and 930. In this technique, the tag is represented by changes in a visual aspect, such as color and/or contrast (shown in FIG. 9 as changes in hatching). These changes in the visual aspect over time may encode the information contained in the tag. To make the tags invisible to a viewer, the changes in the visual aspect may be slight changes from frame-to-frame.

In one implementation, a tag may be placed within a frame of the media signal at the location of the object with which the tag is associated. In another implementation, the tag may be placed within a frame of the media signal irrespective of where the object, with which the tag is associated, is located.

The media signal with the embedded tag(s) may be stored (block 530). For example, the media signal with the embedded tag(s) may be written to a recording medium, such as a DVD or another form of memory. Alternatively, or additionally, the media signal with the embedded tag(s) may be buffered for transmission.

### Exemplary Process for Processing a Tag

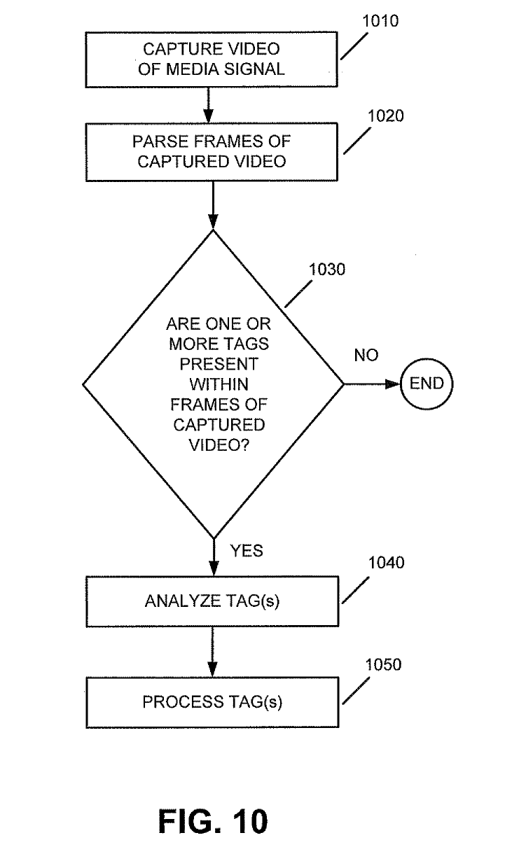

FIG. 10 is a flowchart of an exemplary process for processing a tag within captured video. The process of FIG. 10 may be performed by a mobile device, such as mobile device 250 (FIG. 2).

The process may begin with a media signal being presented on a video display device, such as video display device 230. For example, the media signal may be received and displayed on video display device 230.

Video of the media signal may be captured (block 1010). For example, a user of mobile device 250 may position mobile device 250 so that video capturing device 460 (FIG. 4) of mobile device 250 can capture a video of the media signal being displayed on video display device 230. The user may select the appropriate button(s) on mobile device 250 (e.g., one or more of control buttons 320 and/or one or more keys of keypad 325) to cause video capturing device 460 to capture the video. In one implementation, the user may select a button, or buttons, on mobile device 250 to cause a function, such as a camera function, to be performed by mobile device 250. In response to selection of the button(s), video capturing device 460 may present the video in near real time to display 315 for viewing by the user. Additionally, or alternatively, video capturing device 460 may store the video in a memory, such as storage 420.

In one implementation, video capturing device 460 may capture a small sampling of video, such as one second or less of video. As explained above, a tag may be present once for every thirty frames of the media signal. For a media signal that presents thirty frames per second, for example, capturing one second of video of this media signal may guarantee that a tag (if present) will be included within the captured video. In another implementation, video capturing device 460 may capture more or less than one second of video.

The frames of the captured video may be parsed (block 1020). For example, processing logic 410 may dissect the captured video into individual frames of video. In one implementation, processing logic 410 may process the captured video continuously in approximately real time, as the video is being captured and prior to all of the video being captured. In another implementation, processing logic 410 may process the captured video after all of the video is captured.

It may be determined whether one or more tags are present within the frames of the captured video (block 1030). According to one technique, processing logic 410 may analyze the frames to detect whether a blank frame (e.g., blank frame 630 in FIG. 6) is present. If the blank frame is present, processing logic 410 may determine whether the blank frame includes a tag. According to another technique, processing logic 410 may analyze each of the frames to detect whether a tag is present within a semi-transparent frame (e.g., semi-transparent frame 730 in FIG. 7). In one implementation, processing logic 410 may first analyze the frames to identify the semi-transparent frame, and then determine whether a tag is present within the semi-transparent frame. In another implementation, processing logic 410 may determine whether a tag is present within one of the frames without first identifying a semi-transparent frame. The semi-transparent nature of the semi-transparent frame may facilitate the locating of the tag. This technique may require more processing power and take longer to perform than the technique relating to a blank frame.

According to yet another technique, processing logic 410 may analyze each of the frames to detect whether a frame includes a blank area (e.g., blank area 835 in FIG. 8). If a frame with a blank area is detected, then processing logic 410 may determine whether the blank area includes a tag. This technique may require more processing power and take longer to perform than the technique relating to a blank frame.

According to a further technique, processing logic 410 may analyze the frames to detect changes in a visual aspect, such as color and/or contrast, within a series of frames. This technique may require more processing power and take longer to perform than the technique relating to a blank frame, the technique relating to a semi-transparent frame, and the technique relating to a blank area.

The particular technique used to determine whether a tag is present within the frames of the captured video may depend on the technique used to embed the tag. Alternatively, processing logic 410 may attempt one of these techniques and if the technique does not successfully identify a tag, then processing logic 410 may attempt another one of these techniques until a tag is successfully identified or until all of the techniques have been attempted.

If no tags are detected within the frames of the captured video (block 1030—NO), then the process may end. In this case, a message may be presented to the user to indicate that no tags were detected. If a tag is detected (block 1030—YES), then the tag may be analyzed (block 1040). For example, processing logic 410 may decipher the tag to determine the information that the tag contains. When the tag is included within a blank frame, a semi-transparent frame, or a blank area, deciphering the tag may include decoding the information encoded in the tag. For example, processing logic 410 (or another component) may perform an image processing technique to decipher the tag. When the tag takes the form of a one or two-dimensional symbol, the image processing technique may determine what information the one or two-dimensional symbol represents, much like deciphering a barcode. When the tag is represented by changes in a visual aspect, deciphering the tag may include determining what the changes in the visual aspect represent. In this case, certain changes may map to certain alphanumeric characters or symbols. A table (or some of other form of data structure) or logic may be used to do the mapping of changes in the visual aspect to certain alphanumeric characters or symbols. As explained above, the tag may include an address, a keyword, and/or a message.

The tag(s) may be processed (block 1050). In one implementation, processing logic 410 may be configured to perform certain functions that may depend on what information is included in a tag and/or how many tags are detected. If a single tag is detected and that tag includes an address, then processing logic 410 may use the address to access a web page. For example, processing logic 410 may launch a web browser application and use the web browser application to access a web page associated with the address. Alternatively, or additionally, processing logic 410 may add the address to a bookmark or favorites list. Alternatively, processing logic 410 may initiate a telephone call or send a text message to a telephone number included as the address. Alternatively, or additionally, processing logic 410 may add the telephone number to an address book. Alternatively, processing logic 410 may send an e-mail to an e-mail address included as the address.

If a single tag is detected and that tag includes a keyword, then processing logic 410 may use the keyword to initiate a search. For example, processing logic 410 may initiate a web browser application and populate a search box with the keyword to cause a search to be performed based on the keyword. If a single tag is detected and that tag includes a message, then processing logic 410 may cause the message to be displayed on display 315. This message may also include certain options available to the user and may include links to certain information. If multiple tags are detected, then processing logic 410 may present information regarding these tags and permit the user to select from among the tags.

In another implementation, processing logic 410 may be configured to perform certain functions irrespective of what information is included in a tag and/or how many tags are detected.

### EXAMPLES

### First Example

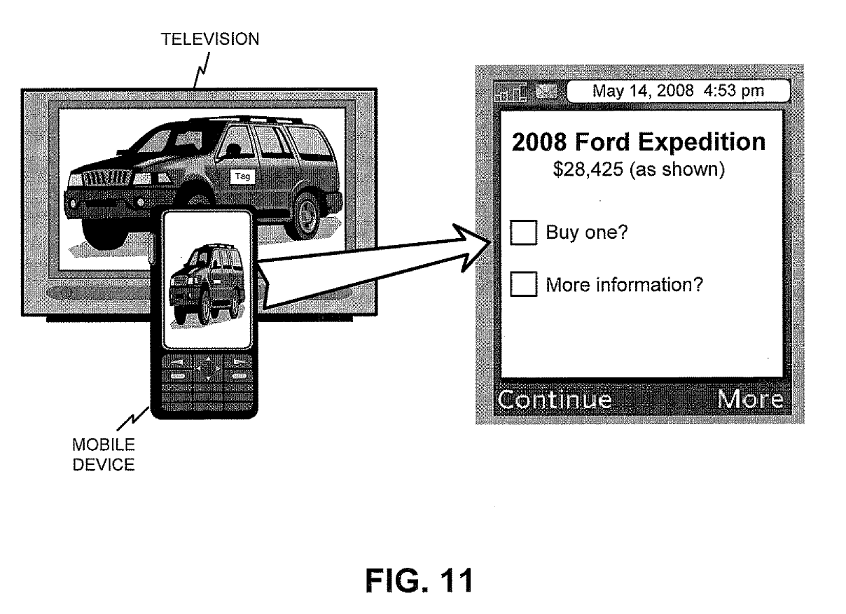

FIG. 11 illustrates a first example in which the information encoded in a tag includes a message. Assume that a user is watching television and a commercial relating to a Ford Expedition is presented on the television. The user is interested in purchasing a new car and wants more information regarding the Ford Expedition. The user gets her mobile device and activates its camera function. In this example, activation of the camera function causes the mobile device to capture a video of a portion of the commercial.

In this example, assume that a tag is embedded within the commercial and that the tag includes a message with multiple addresses and/or multiple keywords. The mobile device may process the video to locate the tag within one or more frames of the video. The mobile device may decipher the tag and present text from the message, contained in the tag, on the display of the mobile device, as shown in FIG. 11. In this case, the text may indicate that the car in the commercial is a 2008 Ford Expedition and costs $28,425 (equipped as shown in the commercial). The mobile device may also present the user with a couple of options, as shown in FIG. 11. For example, the mobile device may present the user with an option to purchase the car and/or an option to obtain more information regarding the car. Each option may be associated with an address or one or more keywords.

For example, the option to purchase the car may be associated with: an address to a web site via which the car can be purchased; a telephone number corresponding to a dealer from which the car can be purchased; or one or more keywords (e.g., Ford Expedition dealer) for obtaining information regarding dealers from which the car can be purchased. Selection of the option may cause: a web browser application to be launched and the web site corresponding to the address to be presented on the display; a telephone call to be initiated or a text message to be sent to the telephone number corresponding to the dealer; or a web browser application to be launched, a search to be performed based on the one or more keywords, and search results to be presented on the display.

The option to obtain more information regarding the car may be associated with: an address to a web site via which additional information can be obtained (e.g., the Ford web site); a telephone number corresponding to a dealer that sells the car; or one or more keywords (e.g., “Ford Expedition”) for obtaining additional information regarding the car. Selection of the option may cause: a web browser application to be launched and the web site corresponding to the address to be presented on the display; a telephone call to be initiated or a text message to be sent to the telephone number corresponding to the dealer; or a web browser application to be launched, a search to be performed based on the one or more keywords, and search results to be presented on the display.

### Second Example

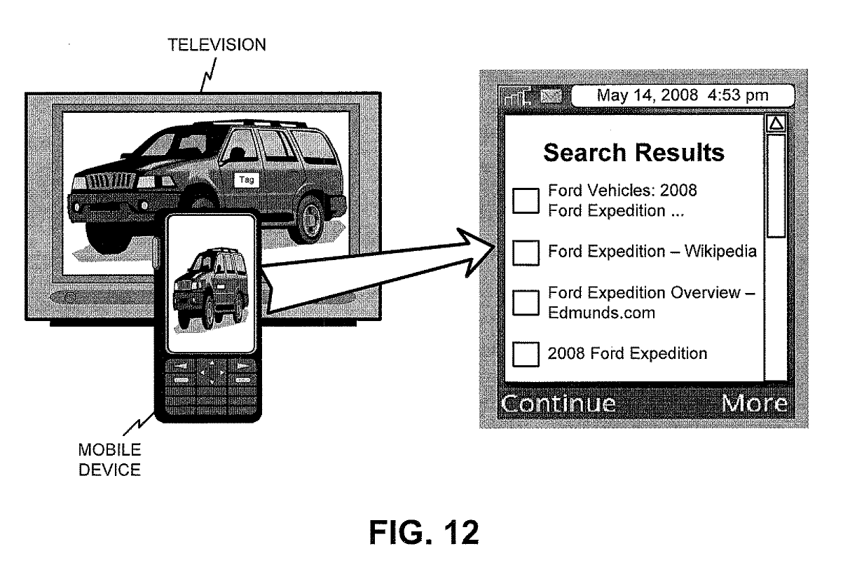

FIG. 12 illustrates a second example in which the information encoded in a tag includes one or more keywords. Assume that a user is watching television and a commercial relating to a Ford Expedition is presented on the television. The user is interested in obtaining additional information regarding the Ford Expedition. The user gets her mobile device and activates its camera function. In this example, activation of the camera function causes the mobile device to capture a video of a portion of the commercial.

In this example, assume that a tag is embedded within the commercial and that the tag includes one or more keywords, such as “Ford Expedition.” The mobile device may process the video to locate the tag within one or more frames of the video. The mobile device may decipher the tag to identify the one or more keywords that the tag contains. The mobile device may cause a web browser application to be launched, a search to be performed based on the one or more keywords, and search results to be presented on the display, as shown in FIG. 12.

The user may be permitted to select one or more of the search results. In response to receiving selection of a search result, the mobile device may access a web page corresponding to the search result and present the web page on the display.

### Third Example

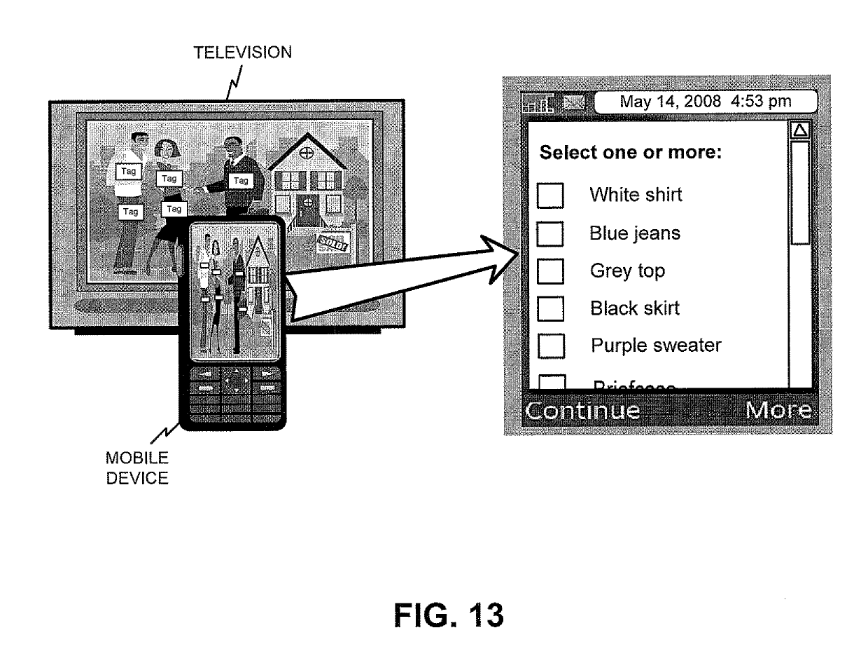

FIG. 13 illustrates a third example in which multiple tags are embedded within one or more frames of a media signal. Assume that a user is watching television and a program relating to purchasing houses is presented on the television. The user likes the briefcase that the real estate agent is carrying and desires more information regarding the briefcase. The user gets his mobile device and activates its camera function. In this example, activation of the camera function causes the mobile device to capture a video of a portion of the program.

In this example, assume that various tags are embedded within the program, including a tag associated with the white shirt the male purchaser is wearing, a tag associated with the blue jeans the male purchaser is wearing, a tag associated with the grey top the female purchaser is wearing, a tag associated with the black skirt that the female purchaser is wearing, a tag associated with the purple sweater that the real estate agent is wearing, and a tag associated with the briefcase that the real estate agent is carrying. The mobile device may process the video to locate the tags within one or more frames of the video and decipher the tags. Assume that each tag includes a message with a short description of an associated object in the video, and an address to a web site that sells the object.

The mobile device may present a list of the objects with which tags have been associated on the display, as shown in FIG. 13. The user may select one or more of the objects from the list. In response to receiving selection of one of the objects, the mobile device may launch a web browser application, cause the web site corresponding to the address, associated with that object, to be presented on the display.

### Fourth Example

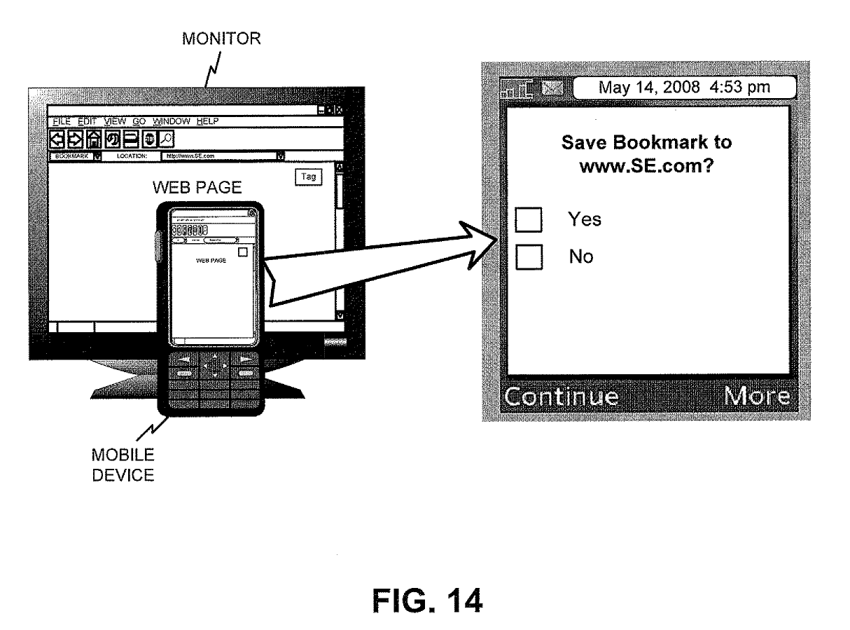

FIG. 14 illustrates a fourth example in which the information encoded in a tag includes an address. Assume that a user is working on her computer and finds a web page in which the user is interested. The user needs to leave for a meeting but wants to record the address for the web page so that the user can return to the web page later. The user gets her mobile device and activates its camera function. In this example, activation of the camera function causes the mobile device to capture a video of the web page.

In this example, assume that a tag is embedded within the web page and that the tag includes the address of the web page. The mobile device may process the video to locate the tag within one or more frames of the video. The mobile device may decipher the tag to identify the address that the tag contains. In this situation, the mobile device may present the user with the option to save the address to a bookmark (or favorites) list, as shown in FIG. 14. The user can then save the address so that the user can return to the web page at any time the user desires.

### Fifth Example

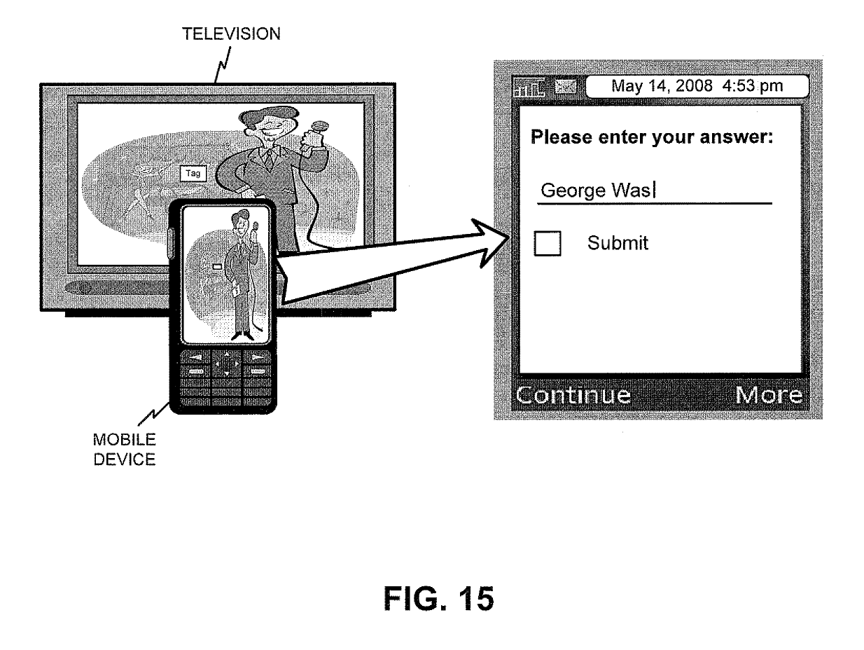

FIG. 15 illustrates a fifth example in which the information encoded in a tag includes a telephone number. Assume that a user is watching a game show on television. At some point, the host of the game show comes on and gives viewers the opportunity to answer a question for a fabulous prize. The user knows the answer to the question, quickly gets his mobile device, and activates its camera function. In this example, activation of the camera function causes the mobile device to capture a video of a portion of the game show.

In this example, assume that a tag is embedded within the game show and that the tag includes a message and a telephone number. The mobile device may process the video to locate the tag within one or more frames of the video. The mobile device may analyze the tag and present text from the message on the display of the mobile device, as shown in FIG. 15. In this case, the text may request that the user enter the answer to the question presented in the game show. The user may use the buttons on the mobile device to enter his answer and select the submit option shown in FIG. 15. In response to receiving selection of the submit option, the mobile device may transmit a text message, containing the user's answer, to the telephone number included in the tag.

### Conclusion

Implementations described herein may capture a video of a media signal, analyze the frames of the video to identify a tag contained within one or more of the frames, decipher the tag to determine the information contained in the tag, and perform a function based on the information contained in the tag. In one or more implementations described above, a mobile device may perform these functions in a manner transparent to a user. The user may simply activate a camera function and, while real time images are presented on the display (e.g., the view finder) of the mobile device, the mobile device may capture the video, analyze the frames (perhaps continuously in approximately real time), identify and decipher a tag, perform some function based on the information in the tag, and present information relating to the performed function to the user on the display.

The foregoing description provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 5 and 10, the order of the blocks may be modified in other implementations. Further, non-dependent blocks may be performed in parallel.

It should be emphasized that the term “comprises” or “comprising” when used in the specification is taken to specify the presence of stated features, integers, steps, or components but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

Further, certain portions of the invention have been described as “logic” that performs one or more functions. This logic may include hardware, such as an ASIC or a FPGA, or a combination of hardware and software.

It will be apparent that implementations, as described above, may be implemented in many different forms of software, firmware, and hardware in the implementations illustrated in the figures. The actual software code or specialized control hardware used to implement these implementations is not limiting of the invention. Thus, the operation and behavior of the implementations were described without reference to the specific software code—it being understood that software and control hardware can be designed to implement the implementations based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method performed by a mobile device, comprising:
capturing video of a media signal;
parsing frames of the captured video;
identifying a tag within one or more of the frames of the captured video, where the tag includes a machine-readable representation of information;
analyzing the tag to determine the information included in the tag; and
presenting particular information based on the information included in the tag.

2. The method of claim 1, where the mobile device includes a video capturing device; and
where capturing video of the media signal includes:
activating the video capturing device, and
recording, by the video capture device, a video of the media signal.

3. The method of claim 1, where the media signal is played on a video display device; and
where capturing video of the media signal includes:
recording a video of the media signal as the media signal is played on the video display device.

4. The method of claim 1, where identifying the tag within the one or more frames of the captured video includes:
locating a blank frame from among the frames of the captured video, and
detecting the tag within the blank frame.

5. The method of claim 1, where identifying the tag within the one or more frames of the captured video includes:
locating a blank area within one of the frames of the captured video, where the blank area is smaller than an entire area of the one of the frames, and
detecting the tag within the blank area.

6. The method of claim 1, where identifying the tag within the one or more frames of the captured video includes:
analyzing a series of the frames of the captured video to identify changes in a visual aspect, and
detecting the tag based on the changes in the visual aspect.

7. The method of claim 1, where the information included in the tag includes an address; and
where presenting the particular information includes:
accessing a web page corresponding to the address, and
displaying the web page as the particular information.

8. The method of claim 1, where the information included in the tag includes a message that contains text; and
where presenting the particular information includes displaying the text of the message as the particular information.

9. The method of claim 1, where identifying the tag within the one or more frames of the captured video includes identifying a plurality of tags within the one or more frames of the captured video; and
where presenting the particular information includes displaying, as the particular information, a selectable list of information regarding each of the plurality of tags.

10. A mobile device, comprising:
a video capturing device to capture video of a media signal presented on a video display device; and
processing logic to:
identify frames of the captured video,
identify a tag within one or more of the frames of the captured video, where the tag includes a machine-readable representation of information,
analyze the tag to determine the information included in the tag, and
perform a particular function based on the information included in the tag.

11. The mobile device of claim 10, where the information included in the tag includes a telephone number; and
when performing the particular function, the processing logic is configured to:
initiate a telephone call based on the telephone number, or
send a text message based on the telephone number.

12. The mobile device of claim 10, where the tag encodes one or more of an address, a keyword, or a message.

13. The mobile device of claim 10, where when identifying the tag within the one or more frames of the captured video, the processing logic is configured to:
locate a blank frame or a semi-transparent frame from among the frames of the captured video, and
detect the tag within the blank frame or the semi-transparent frame.

14. The mobile device of claim 10, where when identifying the tag within the one or more frames of the captured video, the processing logic is configured to:
locate a blank area within one of the frames of the captured video, where the blank area is smaller than an entire area of the one of the frames, and
detect the tag within the blank area.

15. The mobile device of claim 10, where when identifying the tag within the one or more frames of the captured video, the processing logic is configured to:
analyze a series of the frames of the captured video to identify changes in a visual aspect, and
detect the tag based on the changes in the visual aspect.

16. The mobile device of claim 10, where the information included in the tag includes a keyword;
where the mobile device further includes a display; and
where when performing the particular function, the processing logic is configured to:
cause a search to be performed based on the keyword,
obtain search results based on the search, and
present the search results on the display.

17. The mobile device of claim 10, where the tag is associated with an object visible within the media signal on the video display device;
where the mobile device further includes a display; and
where when performing the particular function, the processing logic is configured to present information regarding the object on the display.

18. A mobile device, comprising:
means for capturing video of a media signal that is being displayed on a video display device;
means for identifying frames of video within the captured video;
means for detecting a tag within one or more of the frames, where the tag includes a machine-readable representation of information;
means for analyzing the tag to determine the information included in the tag; and
means for outputting data based on the information included in the tag.

19. The mobile device of claim 18, where the means for identifying the frames of video within the captured video includes:
means for processing the video of the media signal continuously in approximately real time to identify the frames of video while the video of the media signal is being captured.

20. The mobile device of claim 18, where the means for detecting the tag within the one or more frames includes:
means for analyzing a series of the frames of the captured video to identify changes in a visual aspect, and
means for detecting the tag based on the changes in the visual aspect.
